(19) United States
(12) Patent Application Publication
(10) Pub. No.: US 2002/0106445 A1
(43) Pub. Date: Aug. 8, 2002

(54) Chemical liquid coating device and chemical liquid coating method

(75) Inventor: Hideaki Mito, Niigata (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Osaka (JP)

(21) Appl. No.: 10/056,587

(22) Filed: Jan. 23, 2002

(30) Foreign Application Priority Data
Feb. 2, 2001 (JP) 2001-026785

(51) Int. Cl. B05D 5/12

(52) U.S. Cl. 427/58; 118/501

(57) ABSTRACT

A suction portion holds an area on the rear face corresponding to an area other than an electronic device formation area formed on the surface of a substrate. Thus, the temperature inside the electronic device formation area becomes uniform at the time a chemical liquid is applied, so that a chemical film having a constant thickness can be formed. As a result, yield improvements and quality improvements can be achieved in the process of manufacturing electronic devices.

### BACKGROUND OF THE INVENTION

1. Field of the Invention

The present invention relates to a chemical liquid coating device suited for use mainly in the field of manufacturing electronic devices (particularly semiconductor devices) etc. and a chemical liquid coating method.

2. Description of the Related Art

In the following, one example of a conventional coating device of a chemical liquid will be explained with reference to the drawings.

FIG. 11 is a cross-sectional view showing the schematic structure of a conventional chemical liquid coating device. In FIG. 11, 1 is a substantially disciform wafer on which a resist pattern is formed usually by applying a resist liquid and conducting exposure and development processes. 2 is a wafer chuck that is attached by suction to hold the central part of the wafer 1 and enables a rotational coating process with a chemical liquid. 3 is a suction portion of the wafer chuck, which contacts a rear face of the wafer 1 and is attached by suction thereto. 4 is a rotation axis that imparts the rotation of a motor not shown in the drawing to the wafer chuck 2. 5 is an application nozzle for dripping a chemical liquid such as a resist onto the wafer 1. 6 is a cup that is placed around the wafer 1 for preventing a chemical liquid such as a resist liquid or a rinse from being scattered at the time a resist is applied and for recovering the liquid.

Furthermore, FIG. 12 is a top plan view of a state in which the wafer is attached by suction to the chemical liquid coating device of FIG. 11. In FIG. 12, 7 is an area where a large number of electronic devices such as semiconductor integrated circuits are formed as an array in the length and width directions on the wafer 1, which will be cut off into separate chips after a circuit pattern is formed to produce semiconductor integrated circuit devices (electronic devices).

A conventional method of coating a chemical liquid using such a chemical liquid coating device is carried out in the following manner.

First, the wafer 1 is carried into a coating unit shown in FIG. 11 for a coating process, and the suction portion 3 of the wafer chuck 2 is attached by vacuum suction to a rear face of the wafer 1 near its center to hold the wafer 1. At this time, a part that is attached by suction to the suction portion 3 is a predetermined area inside an area on the rear face corresponding to the semiconductor integrated circuit formation area 7. Thereafter, the rotation axis 4 is rotated, and a chemical liquid is dripped onto the wafer 1 through the application nozzle 5. Generally, the wafer 1 is rotated for about 30 to 60 seconds, and the chemical liquid on the wafer 1 is controlled to be of an arbitrary thickness. In addition, there is also a case in which a chemical liquid is dripped onto the wafer 1 in the stopped state, and the wafer 1 is rotated thereafter for the above-mentioned time period. Next, the wafer 1 is dried by rotation and then carried to the next step such as baking.

However, in the above-mentioned structure, there was a problem in that the unevenness in film thickness of the applied chemical liquid was likely to be on the order of several nm on the wafer surface. Particularly when the chemical liquid is a resist liquid or a developer, the unevenness in the applied film thickness becomes apparent as variations in a size of the extremely fine pattern wiring on the wafer surface. An electronic device (particularly a semiconductor device) that performs input-output of images by means of light as in the case of a solid-state image element or a liquid crystal display device has higher sensitivity than the usual semiconductor device, so that even a slight unevenness in the surface characteristics becomes clear when displaying images. Thus, particularly in the manufacturing process of such a semiconductor device, unevenness in the applied film thickness caused characteristic disorders and led to yield deterioration.

Furthermore, although such a fine unevenness in the applied film thickness is not regarded particularly as a problem for an integrated circuit etc. generally used at present, in a semiconductor device having a design rule (wiring width) of not more than 0.1 μm, the absolute value of a pattern wiring size is reduced, and thus the element characteristics are affected, which is considered to appear as a factor for deteriorating yield particularly in its production control and so forth.

### SUMMARY OF THE INVENTION

In view of the foregoing problems, it is an object of the present invention to provide a chemical liquid coating device capable of applying a chemical liquid uniformly to an electron device formation area on a wafer and a chemical liquid coating method.

To achieve the above-mentioned object, a first chemical liquid coating device of the present invention is characterized by including suction means that is attached by suction only to an area on a rear face of a substrate corresponding to an area other than an electron device formation area on a surface of the substrate to hold the substrate, and chemical liquid supply means for supplying a chemical liquid to the surface of the substrate. The suction means in the first chemical liquid coating device is not attached by suction inside an area corresponding to an electronic device formation area. As a result, evenness in the applied chemical liquid is secured inside the electronic device formation area, so that yield improvements and quality improvements can be achieved in the process of manufacturing electronic devices.

It is preferable that the suction means in the above-mentioned first chemical liquid coating device has at least three or more suction portions for attaching by suction to different places of the substrate, and that a center of gravity of the substrate is located inside a polygon formed by connecting vertexes thereof at positions of the substrate where the suction portions are attached by suction. By attaching by suction to the substrate with such a plurality of suction portions and holding the substrate, the substrate can be held and rotated stably.

Alternatively, the suction means may have suction portions that are attached by suction to an entire circumference of the substrate. The use of such suction portions enables the substrate to be attached by suction substantially uniformly over the entire circumference of the substrate, and the substrate can be held and rotated stably. Furthermore, it is no longer necessary to conduct relative positioning between the substrate and the suction means in the rotation direction taking a normal direction of the substrate as the axis.

Furthermore, it is preferable that the suction means is attached by suction to an area of not more than 10 mm inside from an edge of the substrate. Usually, the electronic device formation area is formed in an area of not less than 10 mm inside from an edge of a substrate.

A second chemical liquid coating device of the present invention is characterized by including suction means having a plurality of suction portions, a control part that selects suction portions to be attached by suction to hold a substrate from among the plurality of suction portions such that the suction portions are attached by suction only to an area on a rear face of the substrate corresponding to an area other than an electronic device formation area on a surface of the substrate, and chemical liquid supply means for supplying a chemical liquid to the surface of the substrate. According to the second chemical liquid coating device, among the suction portions included in the suction means, the suction portions located inside an area corresponding to the electronic device formation area are not attached by suction to the substrate. As a result, evenness in the applied chemical liquid is secured inside the electronic device formation area, so that yield improvements and quality improvements can be achieved in the process of manufacturing electronic devices.

In the above-mentioned second chemical liquid coating device, it is preferable that among the plurality of suction portions, suction portions that are not attached by suction to the substrate are separated from the substrate. Accordingly, the applied film of the chemical liquid becomes more even inside the electronic device formation area.

A third chemical liquid coating device of the present invention includes suction means that is attached by suction at least to an entire area on a rear face of a substrate corresponding to an electronic device formation area on a surface of the substrate, and chemical liquid supply means for supplying a chemical liquid to the surface of the substrate. According to the third chemical liquid coating device, the suction means is attached by suction to the entire area corresponding to the electronic device formation area, so that evenness in the applied chemical liquid is secured inside the electronic device formation area. As a result, yield improvements and quality improvements can be achieved in the process of manufacturing electronic devices.

In the above-mentioned third chemical liquid coating device, it is preferable that the substrate has a disc shape, and a suction face of the suction means to the substrate is substantially circular, the suction face having a diameter of not more than a diameter of the substrate and not less than a size that is 10 mm smaller than the diameter of the substrate. By forming the suction face to be smaller than the substrate, a chemical liquid can be prevented from sticking onto the suction face. Also, the electronic device formation area usually is formed in an area of not less than 10 mm inside from the edge of a substrate. Therefore, by determining the diameter of the suction face to be at least [diameter of substrate—10 mm], the entire area corresponding to the electronic device formation area can be attached by suction.

It is preferable that the above-mentioned first, second and third chemical liquid coating devices further include rotation means for rotating the substrate. Accordingly, a rotational coating becomes possible.

Furthermore, a first chemical liquid coating method includes a step of holding a substrate by attaching by suction only to an area on a rear face of the substrate corresponding to an area other than an electronic device formation area on a surface of the substrate, and a step of supplying a chemical liquid to the surface of the substrate.

Furthermore, a second chemical liquid coating method includes a step of holding a substrate by attaching by suction at least to an entire area on a rear face of the substrate corresponding to an electronic device formation area on a surface of the substrate, and a step of supplying a chemical liquid to the surface of the substrate.

According to the first and second chemical liquid coating methods, evenness in the applied chemical liquid is secured inside the electronic device formation area, so that yield improvements and quality improvements can be achieved in the process of manufacturing electronic devices.

In the first and second chemical liquid coating methods, the electronic device may include a wiring pattern with a width of not more than 0.15 μm. As the wiring of an electronic device becomes finer, the unevenness in the applied chemical liquid film in the manufacturing process has a greater effect on the characteristic variations in the electronic device to be obtained. According to the chemical liquid coating method of the present invention, an uniform chemical liquid film can be obtained, so that it is particularly effective in the process of manufacturing an electronic device including such a fine wiring.

### BRIEF DESCRIPTION OF THE DRAWINGS

FIG. 1 is a cross-sectional view of a chemical liquid coating device according to a first embodiment of the present invention.

FIG. 2 is a plan view showing the state in which a wafer is attached by suction in the chemical liquid coating device according to the first embodiment of the present invention.

FIG. 3 is a cross-sectional view of a chemical liquid coating device according to a second embodiment of the present invention.

FIG. 4 is a plan view showing the state in which a wafer is attached by suction in the chemical liquid coating device according to the second embodiment of the present invention.

FIG. 5 is a cross-sectional view of a chemical liquid coating device according to a third embodiment of the present invention.

FIG. 6 is a plan view of a wafer chuck in the chemical liquid coating device according to the third embodiment of the present invention.

FIG. 7 is a plan view showing the state in which a wafer is attached by suction in the chemical liquid coating device according to the third embodiment of the present invention.

FIG. 8 is a cross-sectional view showing the state in which a wafer is attached by suction to a wafer chuck in a chemical liquid coating device according to a fourth embodiment of the present invention.

FIG. 9 is a plan view of a wafer chuck in the chemical liquid coating device according to the fourth embodiment of the present invention.

FIG. 10 is a cross-sectional view showing the state in which a wafer is attached by suction to a wafer chuck in a chemical liquid coating device according to a fifth embodiment of the present invention.

FIG. 11 is a cross-sectional view of a conventional chemical liquid coating device.

FIG. 12 is a plan view showing the state in which a wafer is attached by suction in the conventional chemical liquid coating device.

FIG. 13 is a graph showing a distribution of a resist film thickness at the time a resist is applied using the conventional chemical liquid coating device.

FIG. 14 is a diagram showing measuring points of a film thickness on a wafer.

### DESCRIPTION OF THE PREFERRED EMBODIMENTS

In the following, embodiments of the present invention will be described with reference to the drawings.

### Embodiment 1

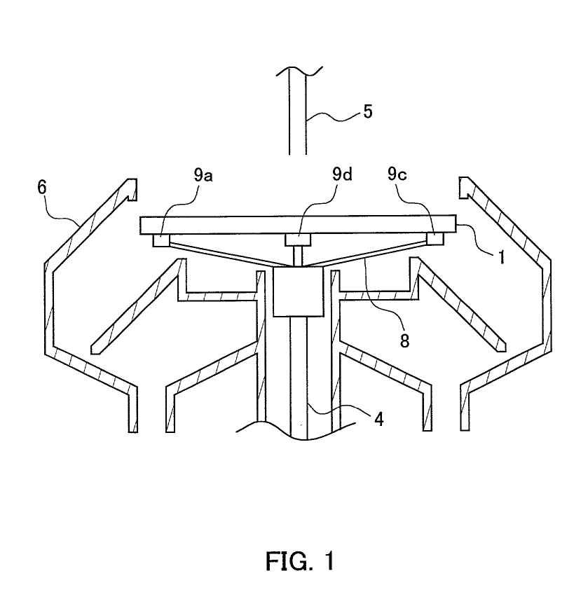

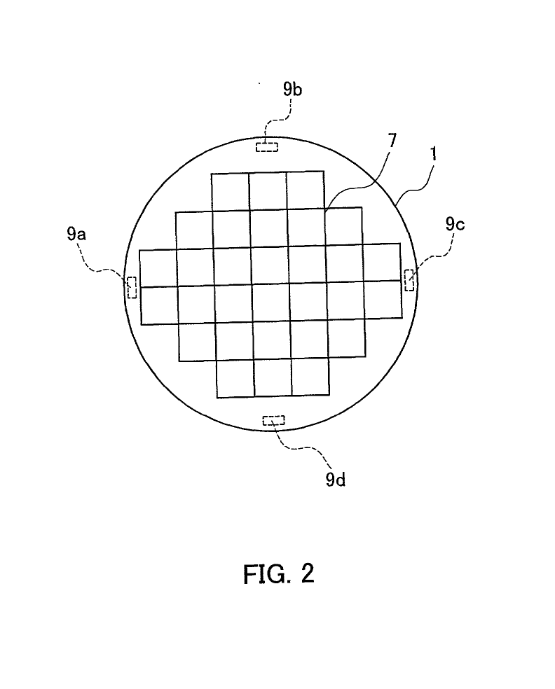

FIG. 1 is a cross-sectional view showing a first embodiment of a chemical liquid coating device in the present invention. FIG. 2 is a top plan view of a wafer attached by suction in the coating device of FIG. 1.

In FIG. 1 and FIG. 2, 1 is a substantially disciform wafer in which a resist pattern is formed usually by applying a resist liquid and conducting exposure and development processes. 4 is a rotation axis that imparts the rotation of a motor not shown in the drawing to a wafer chuck 8. 5 is an application nozzle for dripping a chemical liquid such as a resist onto the wafer 1. 6 is a cup that is placed around the wafer 1 for preventing a chemical liquid such as a resist liquid or a rinse from being scattered at the time a resist is applied and for recovering the liquid. 7 is an area where a large number of electronic devices (particularly semiconductor integrated circuits) are formed as an array in the length and width directions on the wafer 1, which will be cut off into separate chips after a circuit pattern is formed to produce semiconductor integrated circuit devices (particularly semiconductor integrated circuit devices). 8 is a wafer chuck that is attached by suction to hold the wafer 1 and enables a rotational coating process with a chemical liquid. 9a to 9d are suction portions of the wafer chuck 8, which contact a rear face of the wafer 1 and are attached by suction thereto. In the present embodiment, the suction portions 9a to 9d having extremely small contact areas are attached by suction to the rear face of the wafer 1 at four positions in an area corresponding to an area other than the formation area 7 of semiconductor integrated circuits of the wafer 1 to support the wafer 1. The suction portions 9a to 9d are arranged at substantially equiangular intervals along the circumference of a circle centering the center of the wafer 1, which is smaller than the peripheral circle of the wafer 1 and larger than the circumscribing circle of the semiconductor integrated circuit formation area 7. Preferably, the suction portions 9a to 9d are arranged in an area not more than 10 mm inside from an edge of the wafer 1.

A coating method of a chemical liquid according to Embodiment 1 using such a chemical liquid coating device is carried out in the following manner. First, the wafer 1 is carried into a coating unit shown in FIG. 1 for a coating process, and the suction portions 9a to 9d of the wafer chuck 8 are attached by vacuum suction to a rear face of the wafer 1 at predetermined positions to hold the wafer 1. At this time, parts that are attached by suction to the suction portions 9a to 9d are the areas other than the semiconductor integrated circuit formation area 7, that is, the peripheral parts of the wafer 1. Thereafter, the rotation axis 4 is rotated, and a chemical liquid is dripped onto the wafer 1 through the application nozzle 5. Generally, the wafer 1 is rotated for about 30 to 60 seconds, and the chemical liquid on the wafer 1 is controlled to be of an arbitrary thickness. In addition, there is also a case in which a chemical liquid is dripped onto the wafer 1 in the stopped state, and the wafer 1 is rotated thereafter for the above-mentioned time period. Next, the wafer 1 is dried by rotation and then carried to the next step such as baking.

In the above-mentioned example, the four suction portions 9a to 9d are arranged at substantially equiangular intervals along the circumference of a circle centering the center of the wafer 1. However, as long as the suction portions are attached by suction to the rear face of the wafer 1 and supported in an area other than the area corresponding to the semiconductor integrated circuit formation area 7, the present invention is not limited to the above-mentioned example. It is preferable that a number of suction portions that support the wafer 1 is three or more in order to hold the wafer 1 stably. Furthermore, in order to hold and rotate the wafer 1 stably, it is preferable that the suction positions are located in the peripheral parts of the wafer 1, and that a center of gravity of the wafer 1 is located inside a polygon formed by connecting a plurality of suction positions in order. In addition, it is more preferable that the suction positions are arranged at equiangular intervals around the circumference centering this center of gravity.

As described above, the present embodiment has a structure in which the wafer 1 is attached by suction and supported in an area other than the integrated circuit formation area 7 of the wafer 1. In the following, the effects thereof will be explained.

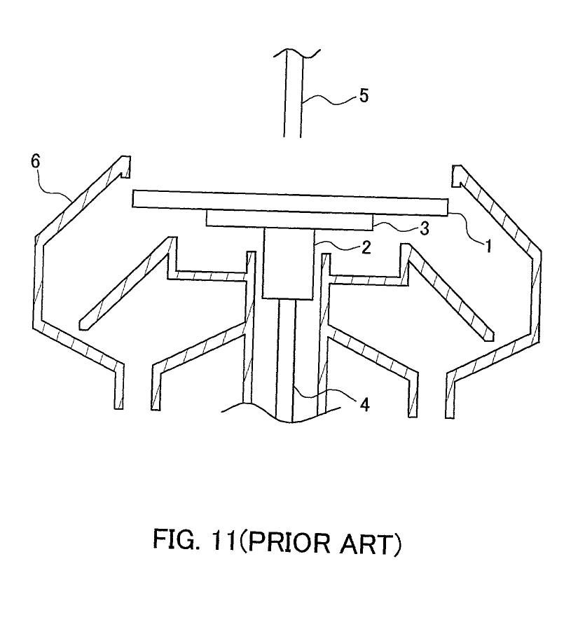

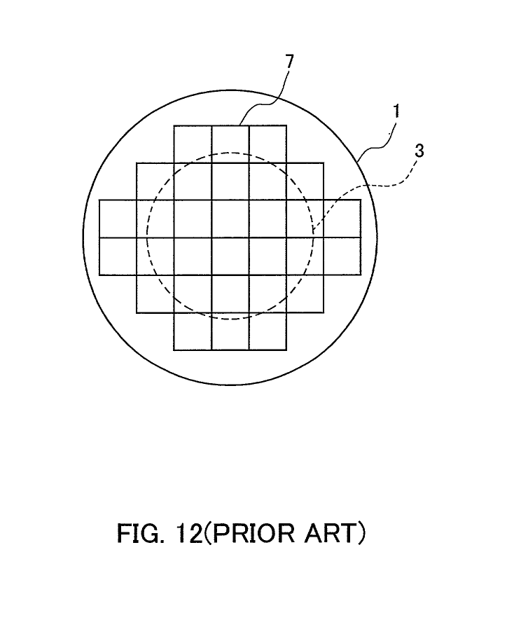

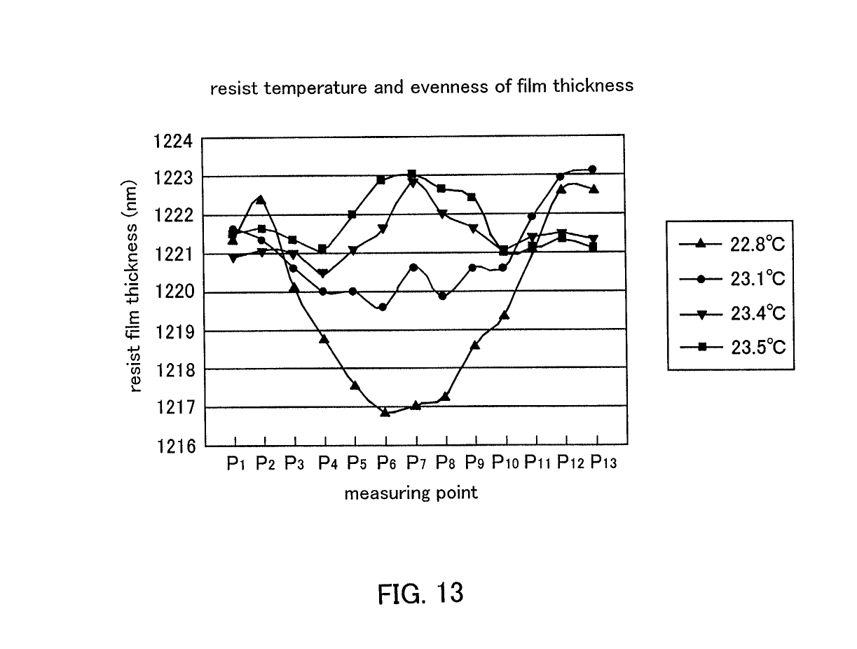

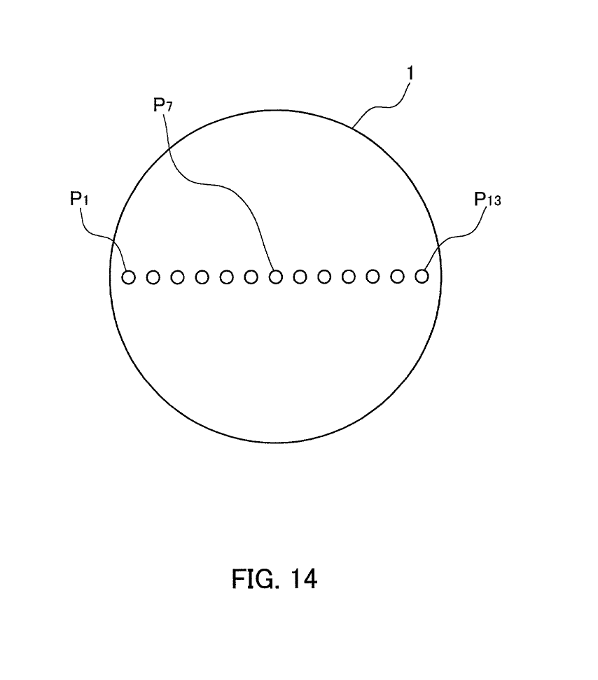

FIG. 13 shows a thickness distribution of resist films obtained by using the conventional coating device illustrated in FIG. 11 and FIG. 12 and applying a resist by changing the temperature of a resist liquid to be supplied in four ways. The lateral axis in FIG. 13 shows the measuring point of a film thickness, and the film thickness was measured from one end to the other of the wafer 1 in the diameter direction at an interval of 15.8 mm in the 13 positions P₁ to P₁₃ as shown in FIG. 14. Here, the measuring point P₇ is made to match with the center of the wafer 1. As is clear from FIG. 13, a resist film having a thickness of about 1.2 μm has unevenness in thickness of about 6 nm. In addition, this condition of unevenness in thickness differs depending on the temperature of the resist liquid. The reason for this dependency of the resist film thickness on the temperature is considered to lie in that the viscosity of the resist liquid is dependent on the temperature.

On the other hand, the conventional coating device as already described has a structure in which the suction portion 3 having a smaller diameter than the wafer 1 is attached by suction to the rear face of the semiconductor integrated circuit formation area 7. As a result, a slight temperature difference arises between the area where the suction portion 3 is attached by suction and the area other than the aforementioned area in the wafer 1, and this temperature difference is considered to cause a difference in the viscosity of the applied resist liquid, thereby causing unevenness in the thickness of the resist film.

To the contrary, the present embodiment has a structure in which the rear face of the area other than the semiconductor integrated circuit formation area 7 is attached by suction. Therefore, the temperature distribution inside the semiconductor integrated circuit formation area 7 can be made substantially uniform regardless of the temperature of the resist liquid (the temperature variance of the resist liquid on the area 7 can be made constantly, preferably, not more than 0.1° C. regardless of the temperature of the resist liquid), and a resist film having an uniform thickness can be formed inside the semiconductor integrated circuit formation area 7. As a result, a semiconductor device in which the wiring pattern size is formed as desired on the surface can be obtained.

As is clear from the above explanation, as long as the wafer 1 can be attached by suction and held such that the temperature distribution becomes substantially uniform inside the semiconductor integrated circuit formation area 7 even in the case where there are differences in the temperature of the chemical liquid to be supplied, the embodiment of this suction portion is not limited to the present embodiment. Hereinafter, this aspect will be explained.

### Embodiment 2

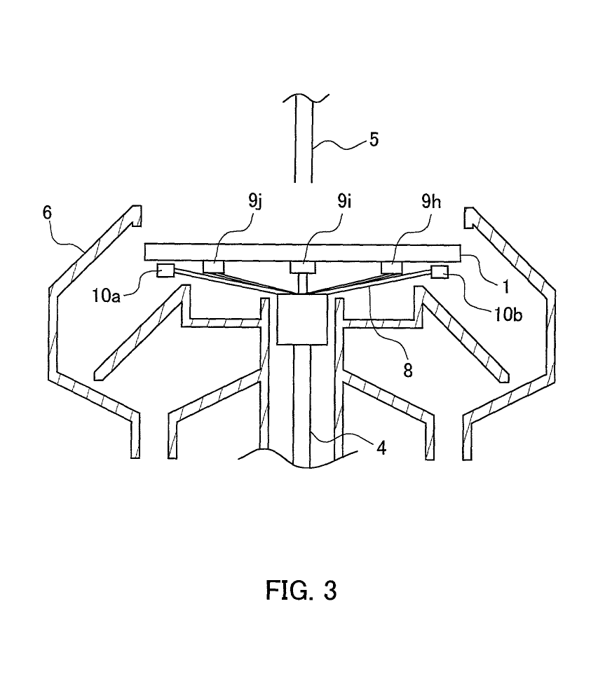

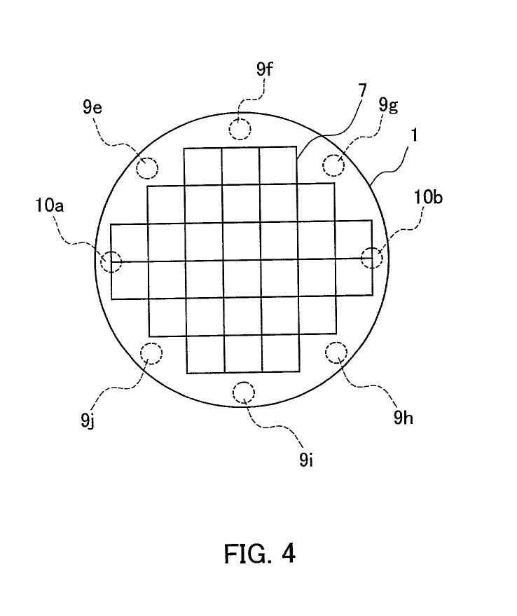

FIG. 3 is a cross-sectional view showing a second embodiment of a chemical liquid coating device in the present invention. Furthermore, FIG. 4 is a top plan view of a wafer attached by suction in the coating device of FIG. 3. In FIG. 3 and FIG. 4, the components which are the same as those shown in FIG. 1 and FIG. 2 of Embodiment 1 have been given the same reference numerals, and the detailed explanations thereof are omitted.

In FIG. 3 and FIG. 4, 9e to 9j and 10a, 10b are suction portions of the wafer chuck 8, which contact the rear face of the wafer 1 and are attached by suction thereto. The respective suction portions 9e to 9j and 10a, 10b all have the same structure, and as shown in FIG. 4, they are arranged at substantially equiangular intervals along the circumference of a circle that is slightly smaller than the peripheral circle of the wafer 1. Moreover, the suction portions 9e to 9j and 10a, 10b are capable of displacement in the upper and lower directions independently from each other. In the present example, the suction portions 9e to 9j located in an area other than the semiconductor integrated circuit formation area 7 of the wafer 1 are attached by suction to the rear face of the wafer 1 to support the wafer 1, but the suction portions 10a, 10b located inside the semiconductor integrated circuit formation area 7 are displaced to slightly lower positions than the suction portions 9e to 9j and are separated from the wafer 1.

The operation of attaching the wafer 1 by suction is carried out in the following manner. Positioning of the wafer 1 in the rotation direction is conducted, and then, the wafer 1 is carried into the coating unit of FIG. 3 for a coating process, and the suction portions 9e to 9j located in the positions that do not overlap with the semiconductor integrated circuit formation area 7 are attached by vacuum suction to the rear face of the wafer 1 to hold the wafer 1. On the other hand, the suction portions 10a, 10b that are located in the overlapping positions with the semiconductor integrated circuit formation area 7 are shifted in the lower direction relative to the wafer 1.

Here, among the suction portions 9e to 9j and 10a, 10b, a control device (not shown in the drawing) included in the coating device controls which suction portion is to be attached by suction and which suction portion is to be shifted in the lower direction. The control device stores data concerning the semiconductor integrated circuit formation area 7 on the wafer 1, and based on these data, the suction portions to be attached by suction (the suction portions 9e to 9j in the above example) are determined. Then, the suction portions that are not attached by suction (the suction portion 10a, 10b in the above example) are shifted toward a lower position to prevent them from being attached by suction by operating an actuator (not shown in the drawing) with a signal from the control device.

As described above, after the operation of attaching the wafer 1 by suction is conducted, a chemical liquid is dripped onto the wafer 1 through the application nozzle 6 as in Embodiment 1 to apply the chemical liquid by rotation. Thus, a chemical liquid such as a resist can be applied uniformly as in Embodiment 1.

### Embodiment 3

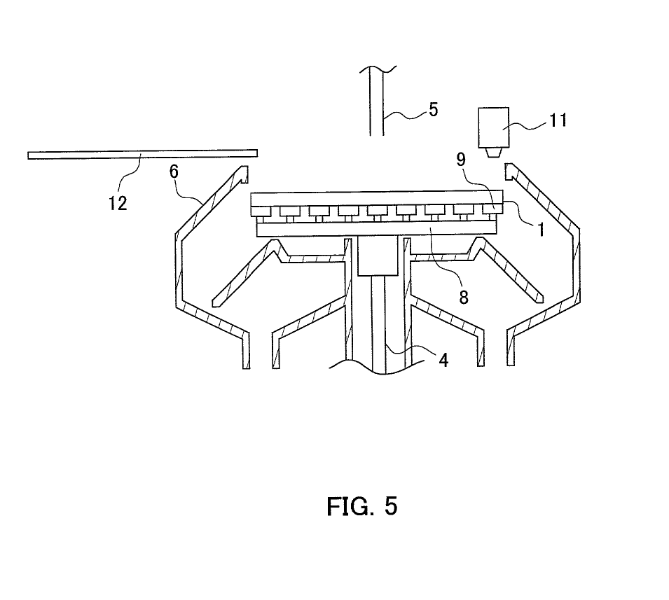

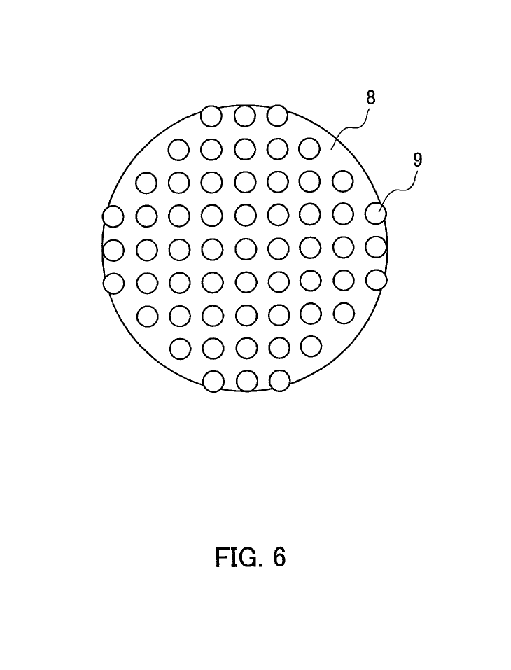

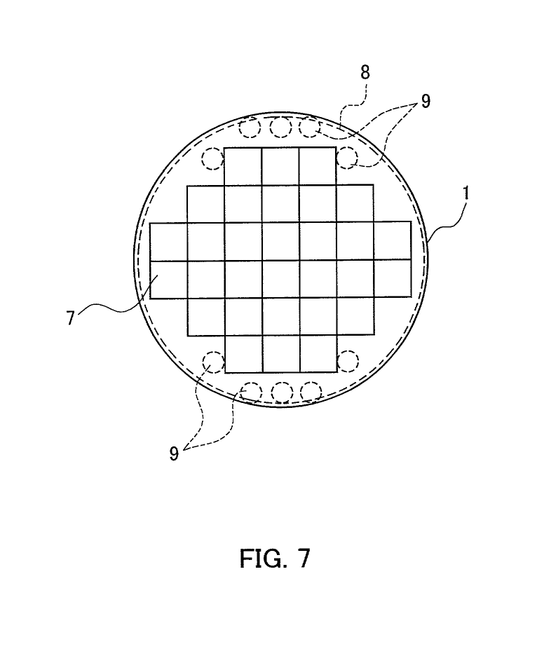

FIG. 5 is a cross-sectional view showing a third embodiment of a chemical liquid coating device in the present invention. Moreover, FIG. 6 is a plan view of a wafer chuck, and FIG. 7 is a top plan view of a wafer attached by suction in the coating device of FIG. 5. In FIG. 5 and FIG. 7, the components which are the same as those shown in FIG. 1 and FIG. 2 of Embodiment 1 have been given the same reference numerals, and the detailed explanations thereof are omitted.

In FIG. 5 to FIG. 7, 9 is a suction portion of the wafer chuck 8, which can be contacted and attached by suction to the rear face of the wafer 1. The suction portion 9 in the present embodiment is disposed in an array in a large number in the form of lattice points over the entire disciform wafer chuck 8. The respective suction portions 9 have the same structure, and the internal channels such as tubes for vacuum suction are all connected to the wafer chuck 8. The respective suction portions 9 are capable of displacement in the upper and lower directions independently from each other. In the present example, among the large number of suction portions 9, the suction portions 9 located in an area other than the semiconductor integrated circuit formation area 7 of the wafer 1 are attached by suction to the rear face of the wafer 1 to support the wafer 1, but the suction portions 9 located inside the semiconductor integrated circuit formation area 7 are displaced to slightly lower positions than the suction portions 9 inside this area 7 and separated from the wafer 1. In FIG. 7, only the suction portions 9 attached by suction to the wafer 1 are shown by the dotted lines. 11 is a wafer position detector (image recognition device) for detecting a notched portion (notch, not shown in the drawing) formed in a predetermined position of the wafer 1 and conducting positioning of the rotation direction by controlling the rotation of the rotation axis 4. 12 is a transport arm for carrying the wafer 1 into and out from the coating device.

The operation of attaching the wafer 1 by suction is carried out in the following manner. First, the wafer 1 is carried into the coating unit shown in FIG. 5 with the transport arm 12 for a coating process, and all (or arbitrary) suction portions 9 of the wafer chuck 8 are attached to the rear face of the wafer 1 by vacuum suction to hold the wafer 1. Next, the rotation axis 4 is rotated to detect a notched portion of the wafer 1 by the wafer position detector 11. Then, the wafer 1 is held by the transport arm 12, and after the wafer 1 is released from being attached by suction with the suction portions 9, the wafer chuck 8 is rotated so that as many suctions portions 9 as possible can be attached by suction to hold the area other than the semiconductor integrated circuit formation area 7. Next, the tranport arm 12 is released from holding, and only the suction portions 9 located in the area other than the semiconductor integrated circuit formation area 7 are attached by suction to hold the wafer 1 once again. On the other hand, the suction portions 9 located in the overlapping positions with the semiconductor integrated circuit formation area 7 are shifted in the lower direction.

Here, among the plurality of suction portions 9, a control device (not shown in the drawing) included in the coating device controls which suction portion is to be attached by suction and which suction portion is to be shifted in the lower direction. The control device stores data concerning the semiconductor integrated circuit formation area 7 and the position of a notched portion on the wafer 1, and based on these data, the suction portions to be attached by suction are determined. Then, the suction portions that are not to be attached by suction are shifted toward a lower position to prevent them from being attached by suction by operating an actuator (not shown in the drawing) with a signal from the control device.

As described above, after the operation of attaching the wafer 1 by suction is conducted, a chemical liquid is dripped onto the wafer 1 through the application nozzle 6 as in Embodiment 1 to apply the chemical liquid by rotation. Thus, a chemical liquid such as a resist can be applied uniformly as in Embodiment 1.

In addition, in the above-mentioned example, the suction portions 9 that hold the wafer 1 were determined after the positioning of the rotation direction between the wafer 1 and the wafer chuck 8 was conducted by rotating the wafer chuck 8. However, the suction portions 9 to be attached by suction may be selected without conducting the positioning of the rotation direction by recognizing the image of a notched portion in the wafer 1 mounted on the wafer chuck 8 or by directly recognizing the image of the semiconductor integrated circuit formation area 7.

### Embodiment 4

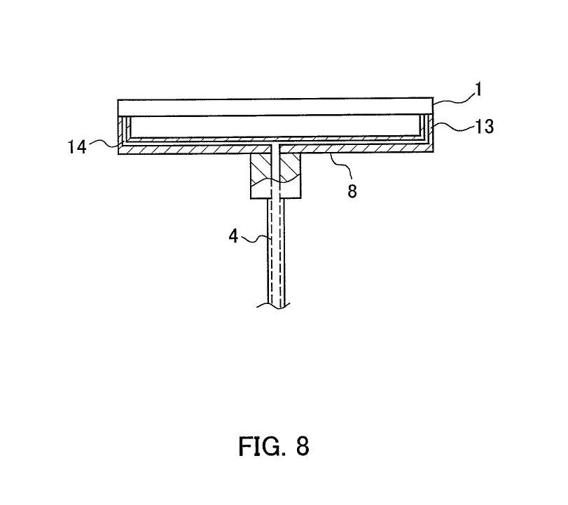

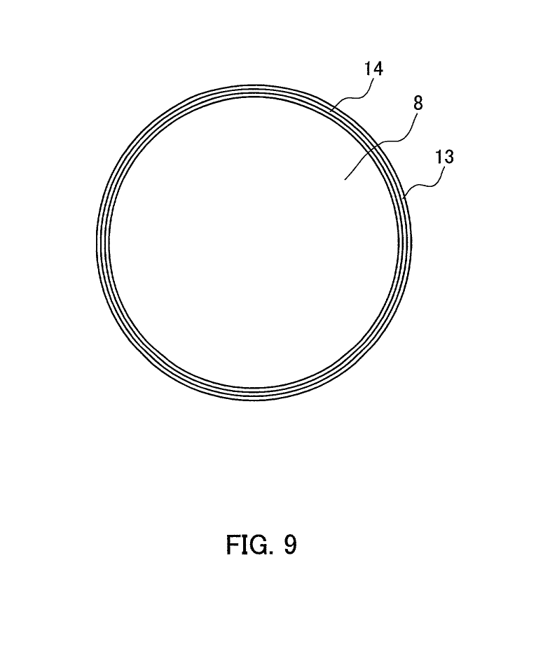

FIG. 8 is a lateral cross-sectional view of a wafer chuck in a chemical liquid coating device according to a fourth embodiment of the present invention. FIG. 9 is a plan view of the wafer chuck. An application nozzle, a cup or the like are the same as those shown in Embodiment 1, and the illustrations thereof are omitted. Furthermore, in FIG. 8 and FIG. 9, the components which are the same as those shown in FIG. 1 and FIG. 2 of Embodiment 1 have been given the same reference numerals, and the detailed explanations thereof are omitted.

In FIG. 8 and FIG. 9, 8 is a wafer chuck that is attached by suction to hold the wafer 1. 13 is a suction portion of the wafer chuck 8, which can contact the rear face of the wafer 1 and be attached by suction thereto. The suction portion 13 includes two cylindrical surfaces having different diameters, arranged so that their axes coincide, and a clearance 14 is formed between the two cylindrical surfaces. The clearance 14 leads to a hollow portion inside the rotation axis 4 and is connected further to a suction apparatus not shown in the drawing.

The outer diameter of the suction portion 13 substantially matches with the diameter of the wafer 1, and the inner diameter of the suction portion 13 is larger than the diameter of the circumscribed circle of the semiconductor integrated circuit formation area 7. Therefore, when the wafer 1 is mounted on the upper end surface of the suction portion 13 as shown in FIG. 8 such that both centers match with each other, the suction portion 13 contacts an area on the rear face of the wafer 1 corresponding to an area other than the formation area of the semiconductor integrated circuit. In this state, the wafer 1 can be attached by suction and held through the clearance 14. In the present embodiment, it is unnecessary to conduct the positioning in the rotation direction between the wafer 1 and the wafer chuck 8 as shown in Embodiments 2 and 3. Furthermore, the wafer 1 can be held with equal suction power over the entire circumference.

Preferably, the suction portion 13 contacts the wafer 1 in an area other than the formation area of the semiconductor integrated circuit and also in an area of not more than 10 mm inside from the edge of the wafer 1.

### Embodiment 5

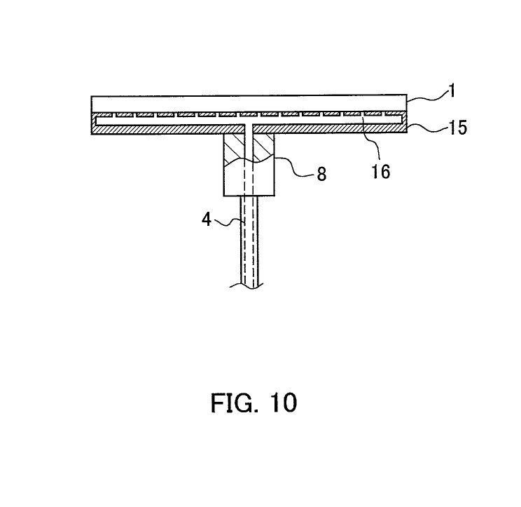

FIG. 10 is a lateral cross-sectional view of a wafer chuck in a chemical liquid coating device according to a fifth embodiment of the present invention. An application nozzle, a cup or the like are the same as those shown in Embodiment 1, and the illustrations thereof are omitted. Furthermore, in FIG. 10, the components which are the same as those shown in FIG. 1 and FIG. 2 of Embodiment 1 have been given the same reference numerals, and the detailed explanations thereof are omitted.

In FIG. 10, 15 is a wafer chuck suction portion fixed on the wafer chuck 8 and has a disc shape (or a short cylindrical shape). It is preferable that the circle on the upper surface of the suction portion 15 where the wafer 1 is mounted has a diameter of not less than [a diameter of the wafer 1—10 mm] and not more than the diameter of the wafer 1. Furthermore, it is preferable that the circle on the upper surface of the suction portion 15 where the wafer 1 is mounted is larger than the diameter of a circumscribed circle of the semiconductor integrated circuit formation area 7 of the wafer 1. The upper surface side of the suction portion 15 that contacts the wafer 1 is provided with a large number of pores 16 for vacuum suction formed with a uniform distribution. All the pores 16 lead to the hollow portion inside the rotation axis 4 and are connected further to a suction apparatus not shown in the drawing.

As shown in FIG. 10, when the wafer 1 is mounted on the upper surface of the suction portion 15 such that both centers match with each other, the suction portion 15 contacts the entire area of the rear face corresponding to the semiconductor integrated circuit formation area of the wafer 1. In this state, the wafer 1 is attached by suction and held through the pores 16.

In the present embodiment, since the entire area of the rear face corresponding to the semiconductor integrated circuit formation area of the wafer 1 contacts the suction portion 15, even if a chemical liquid such as a resist is applied, the temperature in the semiconductor integrated circuit formation area can be made uniform, so that unevenness in the applied film does not occur. Furthermore, it is unnecessary to conduct the positioning in the rotation direction between the wafer 1 and the wafer chuck 8 as in Embodiment 4. Moreover, the area of the rear face corresponding to the semiconductor integrated circuit formation area of the wafer 1 can be held with substantially equal suction power.

In addition, it is also possible to form the circle on the upper surface of the suction portion 15 to have a larger diameter than the diameter of the wafer 1, but in this case, a chemical liquid such as a resist sticks to the exposed upper surface of the suction portion 15 where the wafer 1 is not mounted. Therefore, the size for the upper surface of the suction portion 15 preferably satisfies the above-mentioned conditions.

In the present invention, chemical liquids include a resist applied on a wafer used for a semiconductor manufacturing device, which is exposed to enable a pattern formation, an upper layer antireflection material applied on a resist for reducing multiple interference effects inside the resist, a lower layer antireflection material applied underneath a resist for preventing reflection of exposed light from the substrate, and the like.

As described above, the present invention can hold the wafer without impairing coating evenness inside the electronic device formation area on the wafer either by holding an arbitrary position that is not included in the electronic device formation area formed on the wafer with the wafer chuck or by holding the entire electronic device formation area with the wafer chuck, so that yield improvements and quality improvements can be achieved in the process of manufacturing electronic devices.

The present invention can improve unevenness as small as several nm in the applied film thickness when a chemical liquid such as a resist is applied and has an effect mainly on manufacturing of an electronic device including a pattern wiring of 0.15 μm or less in width. However, the present invention has an even more remarkable effect in the case that includes a pattern wiring of 0.10 μm or less in width.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A chemical liquid coating device comprising suction means that is attached by suction only to an area on a rear face of a substrate corresponding to an area other than an electronic device formation area on a surface of the substrate to hold the substrate, and chemical liquid supply means for supplying a chemical liquid to the surface of the substrate.

2. The chemical liquid coating device according to claim 1, wherein the suction means has at least three suction portions for attaching by suction to different places of the substrate, and a center of gravity of the substrate is located inside a polygon formed by connecting vertexes thereof at positions of the substrate where the suction portions are attached by suction.

3. The chemical liquid coating device according to claim 1, wherein the suction means has suction portions that are attached by suction to an entire circumference of the substrate.

4. The chemical liquid coating device according to claim 1, wherein the suction means is attached by suction to an area of not more than 10 mm inside from an edge of the substrate.

5. The chemical liquid coating device according to claim 1, further comprising rotation means for rotating the substrate.

6. A chemical liquid coating device comprising suction means having a plurality of suction portions,
a control part that selects suction portions to be attached by suction to hold a substrate among the plurality of suction portions such that the suction portions are attached by suction only to an area on a rear face of the substrate corresponding to an area other than an electronic device formation area on a surface of the substrate, and
chemical liquid supply means for supplying a chemical liquid to the surface of the substrate.

7. The chemical liquid coating device according to claim 6, wherein among the plurality of suction portions, suction portions that are not attached by suction to the substrate are separated from the substrate.

8. The chemical liquid coating device according to claim 6, further comprising rotation means for rotating the substrate.

9. A chemical liquid coating device comprising suction means that is attached by suction at least to an entire area on a rear face of a substrate corresponding to an electronic device formation area on a surface of the substrate, and chemical liquid supply means for supplying a chemical liquid to the surface of the substrate.

10. The chemical liquid coating device according to claim 9, wherein the substrate has a disc shape, and a suction face of the suction means to the substrate is substantially circular, the suction face having a diameter of not more than a diameter of the substrate and not less than a size that is 10 mm smaller than the diameter of the substrate.

11. The chemical liquid coating device according to claim 9, further comprising rotation means for rotating the substrate.

12. A chemical liquid coating method comprising a step of holding a substrate by attaching by suction only to an area on a rear face of the substrate corresponding to an area other than an electronic device formation area on a surface of the substrate, and a step of supplying a chemical liquid to the surface of the substrate.

13. The chemical liquid coating method according to claim 12, wherein the electronic device includes a wiring pattern with a width of not more than 0.15 μm.

14. A chemical liquid coating method comprising a step of holding a substrate by attaching by suction at least to an entire area on a rear face of the substrate corresponding to an electronic device formation area on a surface of the substrate, and a step of supplying a chemical liquid to the surface of the substrate.

15. The chemical liquid coating method according to claim 14, wherein the electronic device includes a wiring pattern with a width of not more than 0.15 μm.
